(19) United States
(12) Patent Application Publication
(10) Pub. No.: US 2012/0162748 A1
(43) Pub. Date: Jun. 28, 2012

(54) COMPACT, HIGH BRIGHTNESS LIGHT SOURCES FOR THE MID AND FAR IR

(75) Inventors: Martin FERMANN, Dexter, MI (US); Jie JIANG, Ann Arbor, MI (US); Christopher PHILLIPS, Stanford, CA (US); Martin M. FEJER, Menlo Park, CA (US)

(73) Assignees: THE TRUSTEES OF LELAND STANFORD UNIVERSITY, Stanford, CA (US); IMRA AMERICA, INC.

(21) Appl. No.: 13/325,843

(22) Filed: Dec. 14, 2011

Related U.S. Application Data
(60) Provisional application No. 61/426,327, filed on Dec. 22, 2010.

(51) Int. Cl. G02F 1/365; G02F 1/355; G02F 1/39; G02F 1/35

(52) U.S. Cl. 359/330; 359/326

(57) ABSTRACT

Compact laser systems are disclosed which include ultrafast laser sources in combination with nonlinear crystals or waveguides. In some implementations fiber based mid-IR sources producing very short pulses and/or mid-IR sources based on a mode locked fiber lasers are utilized. Some embodiments may include an infrared source with an amplifier system comprising, in combination, a Tm fiber amplifier and an Er fiber amplifier. A difference frequency generator receives outputs from the Er and/or Tm amplifier system, and generates an output comprising a difference frequency. Exemplary applications of the compact, high brightness mid-IR light sources include medical applications, spectroscopy, ranging, sensing and metrology.

### STATEMENT OF GOVERNMENT LICENSE RIGHTS

This invention was made with Government support under contract FA9550-09-1-0233 awarded by the Air Force Office of Scientific Research. The Government has certain rights in this invention.

### FIELD OF THE INVENTION

The invention relates to compact high brightness light sources for the mid and far IR spectral region, and exemplary applications.

### BACKGROUND

High brightness mid-IR light sources have many applications in medicine, spectroscopy, ranging, sensing and metrology. For mass market applications such sources need to be highly robust, have long term stability and also comprise a minimal component count with a high degree of optical integration. For scientific applications mid-IR light sources based on optical parametric oscillators or amplifiers are well known. However, such sources have limited utility for commercial applications due to their inherent complexity or large optical power requirements.

More recently, semiconductor lasers, and more specifically, quantum cascade lasers have become available that allow a high degree of integration. However, the requirement for cryogenic cooling is generally an obstacle and is not permissible for many applications.

To this date mass producible fiber based mid-IR sources with a high spectral density and operating at high repetition rates have not been produced.

### SUMMARY OF THE INVENTION

Compact laser systems are disclosed, including ultrafast laser sources in conjunction with nonlinear crystals or waveguides.

Ultrafast laser sources based on passively mode locked Tm fiber lasers operating near 2000 nm are particularly attractive. In some embodiments Tm fiber oscillators are combined with Tm fiber amplifiers to increase their pulse energy, where the implementation of cladding pumping also allows average Tm fiber amplifier powers levels to reach the tens of W to hundreds of W range.

Frequency conversion of the ultrafast laser sources to the mid-IR is facilitated via additional frequency shifting using nonlinear crystals or waveguides, such as silicon waveguides, periodically poled lithium niobate (PPLN), optically patterned GaAs, (OPGaAs) and optically patterned GaP (OPGaP) as well as periodically poled KTP, RTA, lithium tantalite, potassium niobate and periodically twinned quartz.

Aperiodic poling periods and dispersion engineered waveguides, provide for efficient frequency shifting of Tm fiber oscillators in the mid-IR spectral region.

In conjunction with difference frequency mixing in nonlinear crystals or waveguides, spectral coverage in the whole mid-IR to far IR spectral region can be obtained.

Difference frequency generation can be improved by combining fiber laser sources operating near 2000 nm with Er amplifiers, allowing for the generation of high power pulses in both the 1550 nm and 2000 nm spectral region.

The mid-IR sources can be used in optical metrology, LIDAR, spectroscopy as well as medical applications such as human tissue treatments.

### BRIEF DESCRIPTION OF THE DRAWINGS

FIG. 1 is a diagram of a portion of a source for mid-IR and far-IR spectral generation.

FIG. 2 shows a measurement of a spectral frequency shift as a function of pulse energy.

FIG. 3 shows a calculation of a spectral frequency shift as a function of wavelength generated in a LiNbO₃ crystal with an aperiodic poling period.

FIG. 4 is a diagram of an alternative embodiment of a source for mid-IR and far-IR spectral generation.

FIG. 5 is a diagram of another alternative embodiment of a source for mid-IR and far-IR spectral generation.

### DETAILED DESCRIPTION

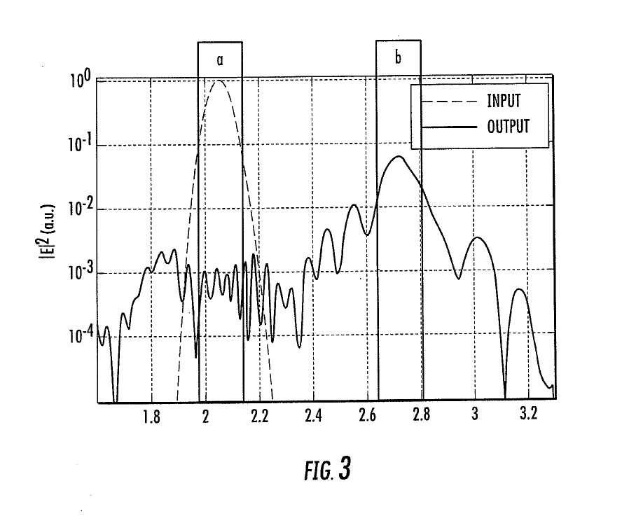

Unless otherwise stated herein, “spectral extent” is the difference, measured in wavelength, between the points where the spectral density of the source is 10% of the peak spectral density, for example as illustrated in FIG. 3.

Mid-IR light generation based on optical fibers or nonlinear waveguides has been suggested, for example, in U.S. Pat. No. 6,885,683 to Fermann et al., entitled “Modular, high energy, widely-tunable ultrafast fiber source”, filed May 23, 2000, which is hereby incorporated by reference in its entirety. For example, Raman shifting and Tm amplifiers are disclosed at least in FIG. 6 and the corresponding text of the '683 patent. Mid-IR frequency generation has also been discussed in U.S. Pat. No. 8,040,929 to Imeshev et al. entitled “Optical parametric amplification, optical parametric generation, and optical pumping in optical fibers systems”, filed Mar. 25, 2005, U.S. patent application Ser. No. 12/399,435 to Fermann et al., entitled “Optical scanning and imaging systems based on dual pulse laser systems”, filed Mar. 6, 2009, and U.S. patent application Ser. No. 11/546,998 to Hartl et al. entitled “Laser based frequency standards and their applications”, filed Oct. 13, 2006. The contents of the U.S. Pat. No. 8,040,929, Ser. No. 12/399,435, and Ser. No. 11/546,998 applications are hereby incorporated by reference in their entirety. A review of compact broadband mid-IR sources can further be found in U.S. Pat. No. 7,519,253 to Islam et al.

Generally, mid-IR sources can be constructed by wavelength conversion using near IR sources as the pump or seed. As discussed in U.S. Pat. No. 8,040,929 to Imeshev et al. Raman-shifting inside a nonlinear fiber is a particularly simple method to convert the output of a near IR source to the mid-IR region. Whereas Raman-shifting in optical fibers is well established, a wavelength conversion process similar to Raman shifting has also been suggested in quasi-phasematched materials, such as periodically poled LiNbO₃ in K. Beckwitt et al., ‘Frequency shifting with local nonlinearity management in nonuniformly poled quadratic nonlinear materials’, Opt. Lett., 29, 763 (2004). However, frequency down shifting was believed to be not feasible unless pulses with a width of at least 5 ps were used. In an experimental demonstration of frequency shifting in a quasi-phase matched nonlinear crystal, no frequency shifting beyond a wavelength of 1650 nm was obtained, as described in F. Baronio et al., ‘Spectral Shift of femtosecond pulses in nonlinear quadratic PPSLT crystals, Opt. Express, 14, 4774 (2006). Moreover, in the work by Baronio et al., very high pulse energies of the order of hundreds of nJ were required which are very difficult to obtain from compact laser architectures.

Fiber based mid-IR sources including very short pulses, such as femtosecond pulses, or mid-IR sources as obtainable with a mode locked fiber laser, are particularly useful for embodiments of compact, high brightness light sources for the mid and/or far IR spectral region.

Femtosecond pulses have many advantages in mid-IR generation. For example, in conjunction with super continuum generation, femtosecond pulses allow more efficient frequency conversion compared to ps or ns pulses, because the peak power of femtosecond pulses is much higher compared to ps or ns pulses for the same pulse energy. Thus mid-IR frequency generation can be performed at high pulse repetition rates. High pulse repetition rates can also maximize the average power or the spectral density of such sources. Another example of the utility of femtosecond pulses generated with mode locked oscillators is their improved spectral coherence when coupling such femtosecond pulses into highly nonlinear fibers, which can be an important aspect in frequency metrology applications.

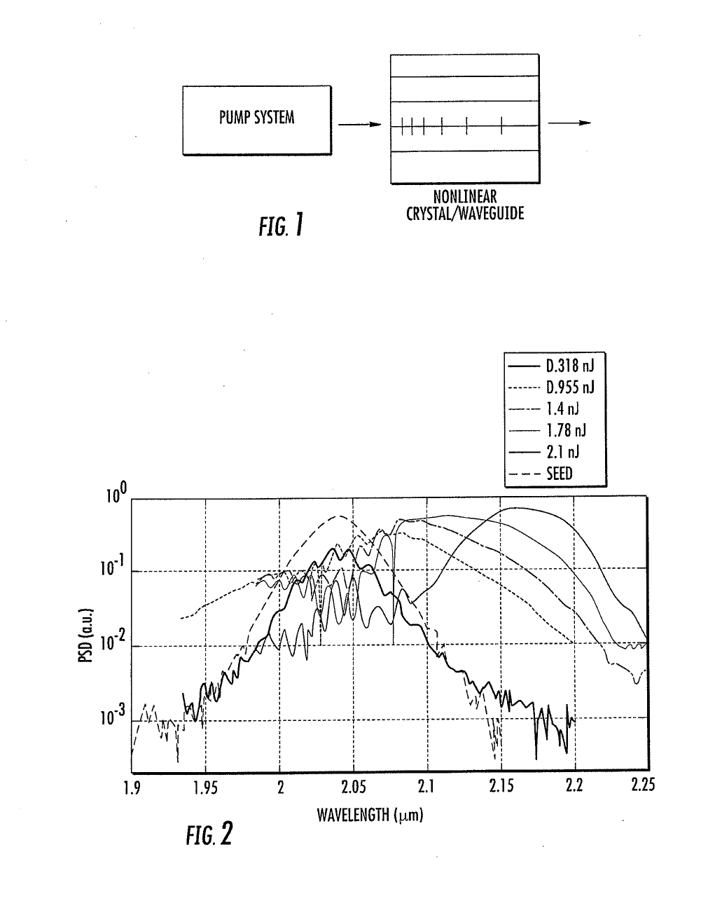

Some components of a wavelength tunable source for the mid-IR spectral region are shown in FIG. 1. The source comprises a laser signal source or laser pump source (shown), and a nonlinear waveguide. Generally, several waveguides can be grown on a single chip and these waveguides can be designed to be parallel to each other as shown in FIG. 1. Moreover, the waveguides can be periodically or aperiodically poled, the latter as indicated by the short lines in FIG. 1.

A laser system operating at a wavelength region of around 2000 nm may be used as the front end of the high brightness source. The laser system could include, for example, a mode locked Tm fiber laser output amplified in a Tm fiber amplifier as described in U.S. Pat. No. 8,040,929 to Imeshev et al., for example, as disclosed in at least FIG. 5, FIGS. 7-13, and the corresponding text of the '929 application. However other laser sources for the front end are also possible, such as Tm/Yb or Ho-based fiber systems or solid-state lasers such as mode locked Cr:ZnSe lasers. Another alternative is the use of a laser system comprising a mode locked Er fiber laser, which is Raman shifted into the 1800-2100 nm spectral range with an optical fiber and subsequently amplified in a Tm fiber amplifier. Such tunable sources for the 2000 nm spectral region have been discussed in U.S. Pat. No. 8,040,929 to Imeshev et al.

In an exemplary implementation the nonlinear crystal in FIG. 1 can comprise a periodically poled LiNbO₃ (PPLN) crystal or a PPLN waveguide. An optical sub-system (not shown) may be included to optically couple the laser source to the nonlinear crystal. The optical subsystem may include any suitable combination of bulk or integrated components, for example lenses, mirrors, fiber couplers and the like. At least one embodiment may comprise an all-fiber coupling arrangement, or contain very few bulk optical elements. Optical isolators (not shown) can further be used to prevent feedback from the nonlinear crystal surfaces into the laser source. The nonlinear crystal can further be anti-reflection coated. The optical sub-system and/or waveguide can further include mode converter(s) implemented with bulk optics, a tapered single-mode fiber, and/or fiber splices. The mode converter(s) may be utilized to simplify optical coupling, to increase the optical coupling efficiency into the waveguide, and also to improve the mode quality of the output beam of the waveguide. Lenses or mirrors (not shown) can further be included at the output of the waveguide for beam collimation. In some embodiments an optical fiber may be disposed at an output of the waveguide to suppress unwanted spectral output, so as to filter the spectrally shifted output appropriately for a particular application.

The nonlinear waveguide can also be designed for super continuum generation as discussed in U.S. patent application Ser. No. 11/546,998 to Hartl et al., for example as disclosed in at least FIGS. 1a) to 1d), and corresponding text of the '998 application. Generally, a waveguide is not required in the nonlinear crystal, though a wave-guiding architecture is useful as it reduces the power requirements for nonlinear frequency generation. When generating a super continuum with the waveguide, the super continuum can also be engineered to produce spectral conversion to a spectral region with enhanced spectral density. For example, when using waveguides with a periodically poled or patterned grating with a certain grating period, the nonlinear waveguide can be designed to produce a spectral frequency shift (SFS). The SFS can be positive (blue-shift) or negative (red-shift). For example to produce a red shift the waveguide needs to be designed to ensure sgn(β_{f}/Δk)=1 and sgn(δν/Δk)=−1, where β_{f} is the group velocity dispersion at the fundamental wavelength; δνₙ=(nₛₕ−n_{f}) is the group index difference between the group index at the second-harmonic wavelength nₛₕ and the group index n_{f} at the fundamental wavelength. Δk=kₛₕ−2k_{f}−K_{g}(z) is the difference in the wavevectors for the second harmonic wavelength kₛₕ, the fundamental wavelength k_{f} and the grating wavevector K_{g}. For aperiodic gratings K_{g} can also be a function of the propagation distance z, i.e. K_{g}(z).

For example, when using a source operating near 2000 nm such as a mode locked Tm fiber laser, frequency shifting into the red spectral region can be obtained in a PPLN waveguide when Δk is negative, i.e. when the grating period is designed to be shorter than the grating period that produces optimum frequency doubling. Frequency shifting from 2000 nm to 3000 nm and further is possible. The frequency shift can further be optimized by using waveguides with enhanced waveguide dispersion, which is possible when using waveguides with small core areas. Waveguide dispersion and frequency shifting can also be maximized by the use of higher-order modes within the waveguide, where both the input and the frequency shifted output can be propagating in the same higher order modes, or where the input and frequency shifted output propagate in different order modes. In order to minimize waveguide degradation due to photorefractive damage or due to nonlinear absorption the use of a pump source with an output wavelength>1700 nm is preferred. Minimization of photorefractive damage and nonlinear absorption is further useful for the generation of high average powers from nonlinear waveguides.

In an experimental demonstration of self-frequency shifting, a frequency down shift of around 9 THz (corresponding to a wavelength shift of 130 nm) was obtained in a periodically poled waveguide (PPLN) with a grating period of 24.3 μm. The PPLN waveguide was manufactured using the reverse proton exchange method. Such waveguide manufacturing methods were, for example, described in K. Parameswaran et al., Opt. Lett., 27, 179 (2002). However, PPLN waveguides made using other manufacturing methods such as milling or etching as well known in the state of the art can also be used. Such manufacturing methods were, for example, disclosed in Sasaura et al., U.S. Pat. No. 7,110,652 ‘Optical waveguide and method of manufacture’ and Yang et al., ‘Fabrication Method for Quasi-Phase Matched Waveguides, U.S. patent application Ser. No. 11/861,447.

In the experimental demonstration a laser source generated pump pulses with around 2 nJ pulse energy and 100 fs pulse width at 2040 nm, which were coupled into the waveguide. The laser source comprised a mode locked Tm fiber laser amplified in a Tm Raman amplifier as, for example, disclosed in U.S. Pat. No. 8,040,929 to Imeshev et al. The optical spectra as a function of pulse energy at the output of the waveguide are further shown in FIG. 2. The seed source spectrum is exemplified by the corresponding dashed line shown in FIG. 2, and the frequency shifted outputs are exemplified by the other lines representing the pulse energy at the waveguide output (0.318 nJ to 2.1 nJ.). Here 2040 nm corresponds to approximately the mean emission wavelength of the source; the laser source further had a spectral extent (as stated above) of 75 nm. As illustrated in FIG. 3, the 10% points correspond to wavelengths of 2000 and 2075 nm. Therefore, most of the source output energy is contained within the spectral extent of the source, covering an approximate spectral range from 2000-2075 nm.

At the highest power levels, a substantial fraction of the output of the waveguide is confined in a spectrally shifted region with a mean wavelength of around 2160 nm. In this particular example the spectrally shifted region has a spectral extent of around 100 nm, covering 2120 to 2220 nm and contains more than around 50% of the total energy of the output within the spectral extent of the spectrally shifted output.

Spectral frequency shifting can be distinguished from super continuum generation by having an enhanced spectral density in a spectrally shifted region. This is further illustrated with respect to FIG. 3, which shows the calculated spectral density at the output of a non-uniformly poled (e.g.: sometimes referred to as aperiodically poled) lithium niobate nonlinear waveguide when using a pump source near 2040 nm (dashed line). From FIG. 3 the spectrally shifted output is in a region of around 2700 nm (solid line). The spectral extent of the laser source is further designated with a) and the spectral region covered by the same bandwidth as the spectral extent of the pump source is designated with b).
1) The spectrally shifted output has a mean emission wavelength different from the mean emission wavelength from the source. (2700 nm and 2040 nm respectively in FIG. 3).
2) In a spectral window with a spectral bandwidth corresponding to the spectral extent of the pump source, the spectrally shifted output contains at least 0.5% of the total output energy of the waveguide. (10% in FIG. 3)
3) There is no spectral overlap between the spectral regions covered by the spectral extent of the source and the region around the mean output wavelength of the frequency shifted output with a bandwidth corresponding to the spectral extent of the source. (regions a and b in FIG. 3).

In the above example, the spectral characteristic was conveniently represented with a spectral window defined by the spectral extent of the source and the source mean emission wavelength, shown at the top of FIG. 3, window a. The spectral extent of the source may correspond to a spectral bandwidth, Δλ. A second, wavelength shifted version of the window having the width, Δλ, is centered at or about the mean emission wavelength of the frequency shifted, output optical pulses (window b in FIG. 3). The energy fraction may be conveniently determined by spectral integration to characterize the enhanced spectral density. The window may be rectangular so as to conveniently determine extent and a fraction of energy enclosed.

Referring back to FIG. 2 it can be seen that the amount of frequency down conversion is power dependent. Thus a continuously wavelength tunable source can be constructed by changing the power injected into the nonlinear waveguide. Near continuous tuning can also be obtained by changing the temperature of the waveguide. Another alternative is to grow several waveguides with different quasi-phase matching gratings or poling parameters on a single chip (as discussed with respect to FIG. 1) and moving the waveguides laterally so as to change the waveguide parameters that are being used for frequency conversion.

In conjunction with OPGaAs or OPGaP waveguides, frequency conversion to 3000 nm and beyond can be expected. Spectral frequency shifts can be further extended with aperiodically poled waveguides. For example, to maximize the spectral frequency shift in poled lithium niobate waveguides the quasi phasematching period is increased along the propagation length.

Moreover, spectral super continuum generation can also be obtained as discussed in U.S. patent application Ser. No. 11/546,998 to Hartl et al. providing a very compact technology platform for mid and far IR spectral generation.

Although in the experimental demonstration we used nonlinear waveguides for efficient frequency down conversion, it is equally possible to replace nonlinear waveguides with nonlinear crystals, though the power requirements for the demonstration of spectral shifting are generally much higher.

In addition to the nonlinear crystals or waveguides discussed, other examples of nonlinear crystals enabling efficient frequency shifting comprise: periodically poled KTP, RTA, lithium tantalate, potassium niobate and periodically twinned quartz. In general most periodically poled nonlinear crystals can be designed for efficient frequency shifting.

In addition to nonlinear waveguides implementing quasi-phase-matching gratings, general nonlinear waveguides can also be implemented for spectral frequency shifting. In this case Raman scattering as known from optical fibers can also produce a spectral frequency shift. It is then still beneficial to use a laser source with an emission wavelength>1700 nm in order to minimize nonlinear absorption inside the waveguide as well as waveguide damage. Such nonlinear waveguides can, for example, comprise nonlinear silicon waveguides, however, other nonlinear materials can also be implemented.

Because spectral frequency shifting produces a frequency shifted output with enhanced spectral density in up or down converted spectral regions, other nonlinear processes can be concatenated with the frequency shifting process to cover an even broader spectral range than possible with just one nonlinear waveguide. For example, a second waveguide can be inserted after the first waveguide in FIG. 2 to enhance spectral up- or down-conversion. Such an implementation is not separately shown.

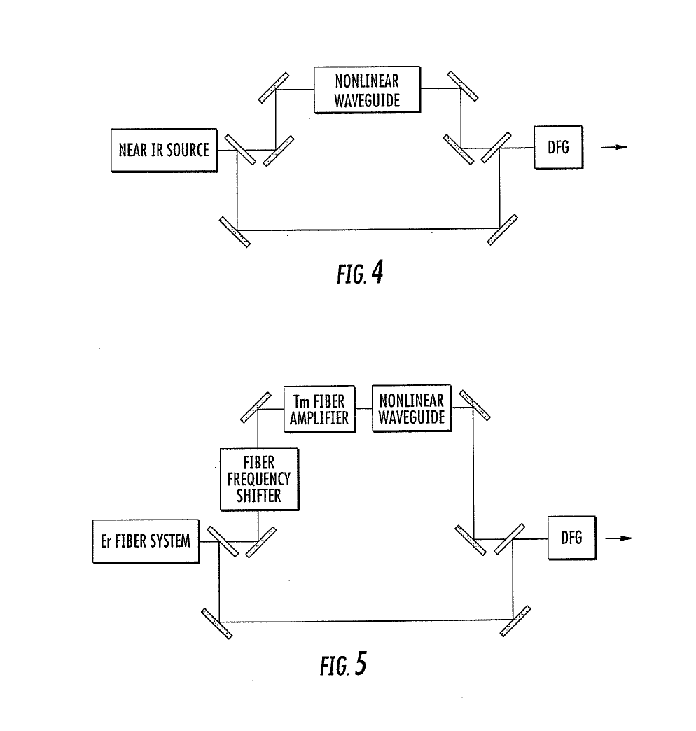

Another alternative is to implement difference frequency mixing for enhanced spectral coverage. An embodiment employing frequency shifting and difference frequency mixing is shown in FIG. 4. The output of the source (e.g.: a Tm fiber laser or any other near infrared source with an output wavelength>1700 nm) is divided into two parts using an optical beam splitter, where the first part is coupled into a first nonlinear crystal to provide nonlinear frequency conversion and the second part is directed along a second optical path. A suitable optical sub-system, for example as described with respect to FIG. 1, may be utilized (not shown). The output of the nonlinear crystal and the second part of the source output are then recombined by a dichroic beamsplitter and the combined output is inserted into a second nonlinear crystal for difference frequency generation. The second nonlinear crystal can also be a nonlinear waveguide configured for difference frequency generation. To maximize the optical power at the difference frequency, optical parametric amplification can also be implemented. The optical arrangement for optical parametric amplification is essentially the same as is shown in FIG. 4. A difference is that for the onset of optical parametric amplification, relatively high pulse energies of the order of a few nJ or more than 10 nJ are utilized. Such high pulse energies can for example be obtained from Tm fiber lasers via the implementation of chirped pulse amplification, as for example disclosed in U.S. Pat. No. 8,040,929.

The second nonlinear crystal can, for example, be constructed from OPGaAs, OPGaP, GaAs or GaP crystals or crystal waveguides. Other crystals implemented for mid-IR generation are known and can also be implemented. For example, GaSe, AgGaSe₂, AgGaS₂ or CdGeAs₂ can be used, just to name a few more examples.

Frequency down-conversion as well as frequency up conversion can be used in the first crystal in conjunction with difference frequency mixing to further enhance spectral coverage of the difference frequency generation process.

In order to extend spectral coverage of difference frequency generation, it is further beneficial to operate the near IR source in a wavelength range from 1700-2000 nm as possible with appropriately designed passively mode locked Tm fiber lasers. Assuming a Tm fiber laser operating at a wavelength of 1850 nm with a bandwidth of 100 nm and frequency down-conversion to 2500 nm, also with a bandwidth of 100 nm, difference frequency mixing can reach a wavelength as short 5000-6000 nm. Wavelengths as long as 20 μm can further be obtained by an appropriate control of the down conversion process. The wavelength range of 5 μm-20 μm is of great interest in molecular spectroscopy. In conjunction with frequency down conversion in OPGaAs or OPGaP, the whole wavelength range from 1800 nm-20000 nm can be covered with a very simple source.

A Tm fiber source operating at a wavelength of 1850 nm can be constructed without the use of Raman soliton formation, using, for example, a mode locked Tm fiber oscillator operating at a wavelength of 1850 nm and higher order soliton formation or chirped pulse amplification in conjunction with a Tm fiber amplifier. Tm fiber based chirped pulse amplification systems were, for example, discussed in U.S. Pat. No. 8,040,929 to Imeshev et al. The implementation of chirped pulse amplification has the additional advantage that very high average powers can be obtained, in the range of 0.1-100 W and even higher. Thus frequency down-converted sources with average powers in the 1-100 W range can in principle be generated which are of great interest for medical applications as well as atmospheric sensing and ranging. In conjunction with optical parametric amplification, pulse energies>1 nJ can further be generated with such fiber based frequency down-converted sources.

Difference frequency generation with large spectral coverage can further be facilitated with the combination of Tm and Er fiber amplifiers as further illustrated in FIG. 5. Here an Er fiber system comprising a mode locked Er oscillator and an optical Er amplification system is used at the front end. A suitable optical sub-system, for example as described with respect to FIG. 1, may be utilized in the system (not shown). The output from the Er fiber system is then split into two parts by an optical beam splitter or a fiber optic coupler. One part of the Er fiber system output is further frequency shifted to provide a seed pulse for a Tm fiber amplifier system. Such a combination of an Er fiber system with a Tm fiber amplifier was, for example, discussed in U.S. patent application '929 to Imeshev et al. The output of the Tm fiber amplifier system can further be tunable as discussed in '929. The output of the Tm fiber amplifier system can further be injected into an optional nonlinear waveguide for further frequency shifting. The output of the nonlinear waveguide or Tm fiber amplifier and the second part of the Er fiber system output are then combined in a nonlinear crystal or waveguide for difference frequency generation. Since the output of the Tm fiber amplifier is wavelength tunable and the difference frequency between the Er fiber system and the nonlinear waveguide can be quite large, very efficient spectral coverage from 1500-20000 nm can be obtained, covering most wavelength regions of interest for near IR to far IR spectroscopy.

In the example discussed with respect to FIG. 5, the roles of the Tm and Er fiber systems can further be reversed. In this case the front end of the system comprises a mode locked Tm fiber oscillator and amplifier system, a fraction of the Tm system output being subsequently frequency upconverted in a fiber frequency shifter before being injected into an Er fiber amplifier system. The output of the Er amplifier and the Tm system are then combined in a nonlinear crystal for difference frequency generation. An additional nonlinear waveguide can further be inserted to frequency shift at least a fraction of the Tm fiber system output before injection in the nonlinear crystal for difference frequency generation.

Thus, a fiber-based laser system may include, in combination, an Er fiber gain medium and a Tm fiber gain medium generating first (Er) and second (Tm) outputs having respective first and second optical frequencies. A difference frequency generator (DFG) receives the first and second outputs having the first and second optical frequencies. The DFG then generates a DFG output that includes a difference of the first and second frequencies.

Thus, the inventors have described the invention in several embodiments.

At least one embodiment includes an infrared source. The source includes a laser system to produce short optical pulses, the optical pulses comprising a first mean emission wavelength greater than about 1700 nm and a first spectral extent. The mean emission wavelength and the spectral extent define a spectral window centered at or about the first mean emission wavelength and having a bandwidth, Δλ. The system includes a nonlinear crystal comprising a quasi-phase-matching grating based on a crystalline material. An optical sub-system optically couples the source to the nonlinear crystal which produces frequency shifted output pulses. The frequency shifted pulses comprise a second, frequency shifted, mean emission wavelength. The frequency shifted output comprises a substantial energy fraction within a second, wavelength shifted, spectral window centered at or about the second mean emission wavelength and having the bandwidth, Δλ. The spectral window and the shifted spectral window have substantially no spectral overlap.

In at least one embodiment a nonlinear crystal may include at least one waveguide.

In at least one embodiment a substantial energy fraction may be greater than about 0.5%.

In at least one embodiment a substantial energy fraction may be greater than about 5%.

In at least one embodiment the laser system may include a Tm, Ho, Tm/Ho or Yb/Tm fiber laser.

In at least one embodiment the laser system may include a solid state laser.

In at least one embodiment the laser system may include a mode locked laser.
In at least one embodiment a nonlinear crystal may be selected from a group comprising: periodically poled lithium-niobate, periodically poled KTP, periodically-poled quartz, periodically poled RTA, periodically poled lithium tantalate, periodically poled potassium niobate and/or orientation patterned GaAs and GaP,

In at least one embodiment the frequency shifted output may be frequency-up-converted.

In at least one embodiment the frequency shifted output may be frequency-down-converted.

The source may further include a second nonlinear crystal configured for spectral frequency shifting, the second nonlinear crystal disposed downstream of the source. In at least one embodiment the source may include a second nonlinear crystal disposed downstream of the source, the second nonlinear crystal configured for difference frequency generation between a fraction of the output of the laser source and the frequency shifted output.

In at least one embodiment the source may include a second nonlinear crystal disposed downstream of the source, the second nonlinear crystal configured for pulse generation at the difference frequency between a fraction of the output of the laser source and the frequency shifted output, where the generation of output at the difference frequency includes optical parametric amplification.

In at least one embodiment the source may be configured to produce a wavelength tunable output, and wherein the wavelength tuning is carried out by lateral translation of the nonlinear crystal and/or heating the nonlinear crystal so as to change the mean emission wavelength of the laser source.

In at least one embodiment the frequency shifted output may have an average power>100 mW.

In at least one embodiment the short optical pulses may include at least one pulse having a pulse width in the range from about 10 fs to 100 ps.

In at least one embodiment the short optical pulses may include at least one pulse having a pulse width in the range from about 10 fs to 1 ps.

In at least one embodiment the spectral window is a rectangular window function having spectral width, Δλ.

In at least one embodiment the optical sub-system may include substantially all-fiber components.

At least one embodiment includes an infrared source. The source includes a fiber-based laser system comprising, in combination, an Er fiber gain medium and a Tm fiber gain medium generating first (Er) and second (Tm) outputs having respective first and second optical frequencies. A difference frequency generator (DFG) receives the first and second outputs having the first and second optical frequencies, and generates a DFG output comprising a difference frequency thereof.

The source may comprising a frequency shifter to frequency shift a portion of one of the first (Er) or second (Tm) outputs to provide either a downshifted or upshifted output portion to seed either a Tm fiber amplifier or an Er fiber amplifier, respectively.

In at least one embodiment the frequency shifter may include optical fiber.

In at least one embodiment the fiber-based system may include an Er fiber amplifier, wherein the Er gain medium comprises a portion of the Er fiber amplifier.

In at least one embodiment the fiber-based system may include an Er fiber oscillator, wherein the Er gain medium comprises a portion of the Er fiber oscillator.

In at least one embodiment the fiber-based system may include an Er fiber laser/amplifier combination, wherein the Er fiber gain medium comprises a portion of the Er fiber laser/amplifier combination.

In at least one embodiment the fiber-based system may include a Tm fiber amplifier, wherein the Tm gain medium comprises a portion of the Tm fiber amplifier.

In at least one embodiment the fiber-based system may include a Tm fiber oscillator, wherein the Tm gain medium comprises a portion of the Tm fiber oscillator.

The fiber-based system may include a Tm fiber laser/amplifier combination, wherein the Tm fiber gain medium comprises a portion of the Tm fiber laser/amplifier combination.

In at least one embodiment an infrared source comprises a second nonlinear crystal disposed downstream of said source, the second nonlinear crystal configured for optical parametric amplification of a frequency shifted output.

In at least one embodiment, optical parametric amplification generates an additional output at the difference frequency of an output of a laser source and a frequency shifted output.

At least one embodiment includes an infrared source. The source includes a laser system producing short optical pulses, the optical pulses comprising a first mean emission wavelength greater than about 1700 nm and a first spectral extent, the mean emission wavelength and the spectral extent defining a spectral window centered at or about the first mean emission wavelength and having a bandwidth, Δλ. The source includes a first nonlinear crystal comprising a quasi-phase-matching grating based on a crystalline material, the first nonlinear crystal producing frequency shifted output pulses, the frequency shifted pulses comprising a second, frequency shifted, mean emission wavelength. A second non-linear crystal is disposed downstream from the first crystal, the second nonlinear crystal configured for the generation of an output at the difference frequency between a fraction of the output of the laser source and the frequency shifted output produced with said first non-linear crystal. The source also includes an optical sub-system to optically couple said source, said first nonlinear crystal, and second nonlinear crystal. The frequency shifted output comprises a substantial energy fraction within a second, wavelength shifted spectral window centered at or about said second mean emission wavelength and having the bandwidth, Δλ. The spectral window and the shifted spectral window have substantially no spectral overlap.

In at least one embodiment the second non-linear crystal is configured for optical parametric amplification of the frequency shifted output, and difference frequency generation includes optical parametric amplification.

In at least one embodiment the second nonlinear crystal is constructed from OPGaAs or OPGaP.

In at least one embodiment the second nonlinear crystal generates an output in the wavelength range from 5 μm-20 μm.

For purposes of summarizing the present invention, certain aspects, advantages and novel features of the present invention are described herein. It is to be understood, however, that not necessarily all such advantages may be achieved in accordance with any particular embodiment. Thus, the present invention may be embodied or carried out in a manner that achieves one or more advantages without necessarily achieving other advantages as may be taught or suggested herein.

Thus, while only certain embodiments have been specifically described herein, it will be apparent that numerous modifications may be made thereto without departing from the spirit and scope of the invention. Further, acronyms are used merely to enhance the readability of the specification and claims. It should be noted that these acronyms are not intended to lessen the generality of the terms used and they should not be construed to restrict the scope of the claims to the embodiments described therein.

What is claimed is:

1. An infrared source comprising:
a laser system producing short optical pulses, said optical pulses comprising a first mean emission wavelength greater than about 1700 nm and a first spectral extent, said mean emission wavelength and said spectral extent defining a spectral window centered at or about said first mean emission wavelength and having a bandwidth, Δλ;
a nonlinear crystal comprising a quasi-phase-matching grating based on a crystalline material;
an optical sub-system to optically couple said source to said nonlinear crystal; said nonlinear crystal producing frequency shifted output pulses, said frequency shifted pulses comprising a second, frequency shifted, mean emission wavelength,
wherein said frequency shifted output comprises a substantial energy fraction within a second, wavelength shifted, spectral window centered at or about said second mean emission wavelength and having said bandwidth, Δλ, wherein said spectral window and said shifted spectral window have substantially no spectral overlap.

2. An infrared source according to claim 1, wherein said nonlinear crystal comprises at least one waveguide.

3. An infrared source according to claim 1, wherein said substantial energy fraction is greater than about 0.5%.

4. An infrared source according to claim 1, wherein said substantial energy fraction is greater than about 5%.

5. An infrared source according to claim 1, wherein said laser system comprises a Tm, Ho, Tm/Ho or Yb/Tm fiber laser.

6. An infrared source according to claim 1, wherein said laser system comprises a solid state laser.

7. An infrared source according to claim 1, wherein said laser system comprises a mode locked laser.

8. An infrared source according to claim 1, wherein said nonlinear crystal is selected from a group comprising, periodically poled lithium-niobate, periodically poled KTP, periodically-poled quartz, periodically poled RTA, periodically poled lithium tantalate, periodically poled potassium niobate and/or orientation patterned GaAs and GaP,

9. An infrared source according to claim 1, wherein said frequency shifted output is frequency-up-converted.

10. An infrared source according to claim 1, wherein said frequency shifted output is frequency-down-converted.

11. An infrared source according to claim 1, further comprising a second nonlinear crystal configured for spectral frequency shifting, said second nonlinear crystal disposed downstream of said source.

12. An infrared source according to claim 1, further comprising a second nonlinear crystal disposed downstream from said source, said second nonlinear crystal configured for difference frequency generation between a fraction of the output of said laser source and said frequency shifted output.

13. An infrared source according to claim 1, wherein said source is configured to produce a wavelength tunable output, and wherein said wavelength tuning is carried out by lateral translation of said nonlinear crystal and/or heating said nonlinear crystal so as to change the mean emission wavelength of said laser source.

14. An infrared source according to claim 1, wherein said frequency shifted output has an average power>100 mW.

15. An infrared source according to claim 1, wherein said short optical pulses comprise at least one pulse having a pulse width in the range from about 10 fs to 100 ps.

16. An infrared source according to claim 1, wherein said short optical pulses comprise at least one pulse having a pulse width in the range from about 10 fs to 1 ps.

17. An infrared source according to claim 1, wherein said spectral window is a rectangular window function having spectral width, Δλ.

18. An infrared source according to claim 1, wherein said optical sub-system comprises substantially all-fiber components.

19. An infrared source comprising:
a fiber-based laser system comprising, in combination, an Er fiber gain medium and a Tm fiber gain medium generating first (Er) and second (Tm) outputs having respective first and second optical frequencies;
a difference frequency generator (DFG) receiving said first and second outputs having said first and second optical frequencies, and generating a DFG output comprising a difference frequency thereof.

20. The infrared source according to claim 19, comprising a frequency shifter to frequency shift a portion of one of the first (Er) or second (Tm) outputs to provide either a downshifted or upshifted output portion to seed either a Tm fiber amplifier or an Er fiber amplifier, respectively.

21. The infrared source according to claim 20, wherein said frequency shifter comprises optical fiber.

22. The infrared source according to claim 19, wherein said fiber-based system comprises an Er fiber amplifier, wherein said Er gain medium comprises a portion of said Er fiber amplifier.

23. The infrared source according to claim 19, wherein said fiber-based system comprises an Er fiber oscillator, wherein said Er gain medium comprises a portion of said Er fiber oscillator.

24. The infrared source according to claim 19, wherein said fiber-based system comprises an Er fiber laser/amplifier combination, wherein said Er fiber gain medium. comprises a portion of said Er fiber laser/amplifier combination.

25. The infrared source according to claim 19, wherein said fiber-based system comprises a Tm fiber amplifier, wherein said Tm gain medium comprises a portion of said Tm fiber amplifier.

26. The infrared source according to claim 19, wherein said fiber-based system comprises a Tm fiber oscillator, wherein said Tm gain medium comprises a portion of said Tm fiber oscillator.

27. The infrared source according to claim 19, wherein said fiber-based system comprises a Tm fiber laser/amplifier combination, wherein said Tm fiber gain medium comprises a portion of said Tm fiber laser/amplifier combination.

28. An infrared source according to claim 1, further comprising a second nonlinear crystal disposed downstream from said source, said second nonlinear crystal configured for optical parametric amplification of said frequency shifted output.

29. An infrared source according to claim 28, wherein said optical parametric amplification generates an additional output at the difference frequency of said output of said laser source and said frequency shifted output.

30. An infrared source comprising:
a laser system producing short optical pulses, said optical pulses comprising a first mean emission wavelength greater than about 1700 nm and a first spectral extent, said mean emission wavelength and said spectral extent defining a spectral window centered at or about said first mean emission wavelength and having a bandwidth, Δλ;
a first nonlinear crystal comprising a quasi-phase-matching grating based on a crystalline material, said first nonlinear crystal producing frequency shifted output pulses, said frequency shifted pulses comprising a second, frequency shifted, mean emission wavelength;
a second non-linear crystal disposed downstream from said first crystal, said second nonlinear crystal configured for the generation of an output at the difference frequency between a fraction of the output of said laser source and said frequency shifted output produced with said first non-linear crystal; and
an optical sub-system to optically couple said source, said first nonlinear crystal, and second nonlinear crystal,
wherein said frequency shifted output comprises a substantial energy fraction within a second, wavelength shifted, spectral window centered at or about said second mean emission wavelength and having said bandwidth, Δλ, wherein said spectral window and said shifted spectral window have substantially no spectral overlap.

31. The infrared source according to claim 30, wherein said second non-linear crystal is configured for optical parametric amplification of said frequency shifted output, and said difference frequency generation includes optical parametric amplification.

32. An infrared source according to claim 30, said second nonlinear crystal constructed from OPGaAs or OPGaP.

33. An infrared source according to claim 30, said second nonlinear crystal generating an output in the wavelength range from 5 μm-20 μm.
